(19) United States
(12) Patent Application Publication
(10) Pub. No.: US 2007/0162382 A1
(43) Pub. Date: Jul. 12, 2007

(54) System and method for transferring funds from the united states to nationals in ofac-regulated countries

(75) Inventor: Paul H. Lesniak, Newark, DE (US)

Correspondence Address: CONNOLLY BOVE LODGE & HUTZ, LLP, P O BOX 2207, WILMINGTON, DE, 19899, US

(73) Assignee: IKOR Industries, Inc., Newark, DE (US)

(21) Appl. No.: 10/555,282

(22) PCT Filed: May 6, 2004
(86) PCT No.: PCT/US04/14242

§ 371 Date: Aug. 29, 2006

Related U.S. Application Data
(60) Provisional application No. 60/468,222, filed on May 6, 2003.
(60) Provisional application No. 60/498,252, filed on Aug. 27, 2003.

(51) Int. Cl. G06Q 40/00

(52) U.S. Cl. 705/39

(57) ABSTRACT

A system and method for transferring funds from the United States to nationals located in one or more countries regulated by the Office of Foreign Assets Control (“OFAC”) of the U.S. Department of the Treasury use a primary/secondary card. A U.S. bank issues a primary card to a U.S. citizen or legal resident living in the United States, and one or more secondary cards on the same account to the nationals who are related to the primary cardholder. The primary cardholder presents documentation assuring the U.S. bank that each payee of the transfer (national) qualifies for family remittance under OFAC regulations. The U.S. bank limits the credit available to each national secondary cardholder to the amount(s) permitted under the current OFAC requirements, and while at the same time offering additional credit to the primary cardholder under the terms of its agreement with the primary cardholder.

### CLAIM FOR PRIORITY

The present application claims priority of U.S. Provisional Patent Application Ser. Nos. 60/468,222 and 60/498,252, filed May 6, 2003 and Aug. 27, 2003, respectively, the disclosures of which being incorporated by reference herein in their entireties.

### BACKGROUND OF THE INVENTION

A. Field of the Invention

The present invention relates generally to the banking industry, and, more particularly to a system and method for transferring funds from the United States to nationals located in countries regulated by the Office of Foreign Assets Control (“OFAC”) of the U.S. Department of the Treasury, such as Cuba.

B. Description of the Related Art

Currently, Cubans living in the United States (or Cuban Americans) may provide cash funds to their relatives living in the Republic of Cuba (or Cuban nationals). The U.S. Department of the Treasury enables the fund transfer process through a program called the “Family Remittance Forwarders” program. Current U.S. regulations permit Cuban Americans who are U.S. residents or citizens to send up to $300 every three months ($1,200 annually) to family members in Cuba.

Three companies offer services that enable such funds to be wired to Cuban family members: Western Union (of Paramus, N.J.), MoneyGram Payment Systems, Inc. (of Lakewood, Colo.), and Tran$card Canada Ltd. (of Toronto, Canada). Currently this can be accomplished only through an approved Cuban agent working for one of these three companies, and must be performed in person. Such transfers may only be performed once every three months, and the Cuban American must attest to the fact that the recipient of these funds is not a senior-level official of the Communist Party of the Republic of Cuba or a senior-level official of the government of Cuba. This assurance must be in the form of an affidavit signed by the Cuban American. Each company is a family remittance forwarder (“FRF”), which means they hold a license from the Office of Foreign Assets Control (“OFAC”) of the U.S. Department of the Treasury authorizing them to provide payment forwarding services and acts on behalf of donors, who wish to provide services in connection with the collection or forwarding of remittances to Cuba.

Western Union began its wire transfer services between the United States and the Republic of Cuba around mid-1999. Initially, Western Union only offered the wire transfer service in the State of Florida, but has expanded to other states. In 1999, MoneyGram was still awaiting a license from the OFAC to commence electronic fund transfer services between the United States and Cuba. In 1999, Tran$card reportedly disbursed $30 million from the United States to Cuba.

The companies offering the wire-based transfer systems have limited locations, and require in-person transactions. They also present difficult financial reporting issues for the U.S. government. Specifically, it is difficult for the OFAC to keep track of who transferred the money, how much money was transferred, and when the money was transferred—all important questions in light of the $300 per quarter regulations imposed by the OFAC.

OFAC regulations are not limited to Cuba. OFAC limits the amount and provides regulations for funds that may be transferred to certain countries, hereinafter referred to “OFAC-regulated countries” or “countries regulated by OFAC”. Presently, the following countries are countries regulated by OFAC: Balkans, Burma, Cuba, Iran, Iraq, Liberia, Libya, North Korea, Sierra Leone, Sudan, and Zimbabwe. Depending upon the political state of the world, OFAC may add or subtract countries from the list.

Thus there is a need in the art to provide a payment system that transfers funds to nationals located in OFAC-regulated countries from the United States and overcomes the problems of the related art.

### SUMMARY OF THE INVENTION

The present invention satisfies this need by providing a system and method for transferring funds to nationals located in OFAC-regulated countries from the United States using a primary/secondary card-based system.

Additional advantages of the invention will be set forth in part in the description which follows, and in part will be learned from the description, or may be learned by practice of the invention. The advantages of the invention will be realized and attained by means of the elements and combinations particularly pointed out in the appended claims.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments of the invention and together with the description, serve to explain the principles of the invention. In the drawings:

FIG. 1 is a schematic diagram showing a system and method in accordance with an embodiment of the present invention;

FIG. 2 is a schematic diagram showing a system and method in accordance with another embodiment of the present invention;

FIG. 3 is a schematic diagram showing hardware useful with the system and method of the present invention; and

FIG. 4 is a schematic diagram showing a client, server, or client/server entity of the hardware shown in FIG. 3.

### DESCRIPTION OF EMBODIMENTS OF THE INVENTION

Reference will now be made in detail to the exemplary embodiments of the invention, examples of which are illustrated in the accompanying drawings. Wherever possible, the same reference numbers will be used throughout the drawings to refer to the same or like parts.

Although the description that follows uses Cuba as an example of an OFAC-regulated country, the system and method of the present invention is not limited for use with Cuba. Rather, the present invention may be used in any OFAC-regulated country. Thus, in the description that follows, “Cuba” may be replaced with another OFAC-regulated country, and the invention applies equally to such other OFAC-regulated country.

A. Introduction

The system and method of the present invention permits U.S.-based banks to take on additional loans from a niche-market with the United States. The niche-market is the Cuban population or population from other OFAC-regulated countries living in the United States (referred to herein as Cuban Americans or sponsors) who have relatives living in Cuba or other OFAC-regulated countries (referred to herein as Cuban nationals). In the past three years, many of these Cuban Americans have been wiring funds to their relatives living in Cuba using the wire-based systems discussed above.

The opportunity for U.S.-based banks comes from the current fund transfer process approved by the OFAC. More specifically, the system and method of the present invention would enable these banks to capture loans for transfers and fees associated with the transfers through a primary/secondary card-based system, thereby increasing the outstanding loans the banks currently carry.

The primary or secondary cards disclosed herein may include, but are not limited to, one of the following: credit cards, charge cards, debit cards, automated teller (ATM) cards, smart cards, pre-paid cards, secured cards, or combinations thereof.

A credit card is a device used to obtain consumer credit at the time of purchasing an article or service. Credit cards may be issued by a business, such as a department store or an oil company, to make it easier for consumers to buy their products. Alternatively, credit cards may be issued by third parties, such as a bank or a financial services company, and used by consumers to purchase goods and services from other companies. There are two types of cards—credit cards and charge cards. Credit cards such as VISA® and MasterCard® allow the consumer to pay a monthly minimum on their purchases with an interest charge on the unpaid balance. Charge cards, such as American Express®, require the consumer to pay for all purchases at the end of the billing period.

A debit card is a payment card attached to a checking or savings account. VISA® and MasterCard® debit cards are offline or signature-only cards that act like electronic checks that may take a day or two to clear the bank. Debit cards with personal identification number (“PIN”) access are online cards and immediately access your bank account.

An ATM card is a plastic card that looks like a credit card. It allows you to do the same things at a bank machine or ATM as you would in person at a bank. You can get cash, deposit money, check account balances, and receive a copy of your statement, all electronically, by using your ATM card and the password to your account, which is called your PIN.

Smart cards are credit cards with an embedded silicon wafer or computer chip. Commonplace credit cards have magnetic stripes that can only hold a limited amount of information. Smart cards with their larger data capacity can execute many more tasks than your average credit card. For example, a smart card can hold e-cash, provide secure access to buildings, be programmable as a hotel room key, be used for mass transit payment and track your rewards program points and/or miles. Also smart cards can provide access to a credit line or a bank account, and hold prepaid amounts on the card. What this means is that you can eliminate a wallet full of cards by needing just one or two cards. Smart cards having such increased functionality also allow for a much higher level of security.

A pre-paid card (also known as a “gift card”) is funded in advance and is similar to a gift certificate. You purchase the card in a fixed denomination or have it loaded with a certain amount of value. Purchases made with the pre-paid card are then deducted or debited against the prepaid amount.

A secured card is a credit card with a collateral savings account. The savings account may be a CD, money market account, or a non-interest bearing account. Savings will be liquidated and applied to the balance if you default on payments to the credit card. This gives the issuer some insurance or assurance that you will handle your credit card account responsibly. Secured cards are for consumers with poor credit or no credit.

The primary cardholders (the Cuban Americans) would be highly motivated to obtain such primary/secondary-based cards from the bank, maintain a good credit rating, and be less sensitive to interest rates. This is due to the fact that families within Cuba rely upon their Cuban American relatives to send continued financial support. The Cuban Americans would have the additional incentive to change their method of transferring funds. First, the system and method of the present invention would provide a much more convenient method to execute a transfer because it only requires the Cuban nationals to take action on their end. Second, the present invention potentially reduces the cost per transfer for the payer (Cuban American). In some cases, as much as fourteen percent of the total fund amount transferred is paid in a fee. Additional cost savings in the payer's personal cash flow may be realized by placing the transfer activity on the card. The primary cardholder may then extend the transfer and fee amounts over a period of time.

B. Overview of the System and Method

The system and method of the present invention would have the U.S. bank issue primary cards to Cuban Americans living in the United States, and additional or secondary cards on the same account to Cuban nationals who are related to the primary cardholder, as required by U.S. law. Monthly statements will go to the primary cardholder, which will provide the U.S. bank with security when issuing cards to those participating in the program since the U.S. bank will be the only authority to approve or deny the primary cardholders. This will allow the U.S. bank to control any potential losses, and will follow the OFAC regulations. To follow these regulations, the primary cardholder will present documentation assuring the U.S. bank that the payee of the transfer qualifies under the OFAC regulations. The U.S. bank would use its internal computing systems to limit the credit available to Cuban nationals per each quarter ($300 per quarter under current regulations), and thus, meet current OFAC requirements.

An affiliated financial institution (or bank) in Cuba would handle the distribution of transfer funds in Cuba to the Cuban nationals. The affiliated Cuban bank would permit each Cuban national holding a card issued by the primary cardholder, via the U.S.-based bank, to present his/her secondary card and effectively withdraw these funds through the affiliated Cuban bank. Should additional appropriate security measures be established, the Cuban national may also use his/her secondary card in one of the several new Automated Teller Machines (ATMs) scheduled to be installed throughout Cuba. Current plans have the ATMs distributing Pesos. Ultimately it has been proposed that Cuban merchants would accept a secondary cardholder's (Cuban national's) card, and payments to appropriate merchants at the correct amounts would be made by the affiliated Cuban bank should the U.S.-based bank approve of such a procedure. However, the first option is the quickest and easiest to implement, i.e., where the secondary cardholder presents the secondary card to the affiliated Cuban bank for withdrawal from the primary cardholder's account, as limited by the security technology and pursuant to OFAC regulations.

C. Opportunities for the U.S.-Based Bank

The system and method of the present invention provides at least three opportunities for the U.S.-based bank. First, the present invention provides additional credible and reliable cardholders from the Cuban American community and approved Cuban nationals. The present invention adds a large number of loans to the U.S. bank's portfolio from the transferred funds and fees, as well as any additional charges the primary cardholder may execute with the primary card.

Second, the present invention enables the U.S. bank to build bank loyalty with these two groups of Cubans due to the bank's willingness to be supportive of the Cubans' personal goals and needs. This loyalty and the unique opportunity for the Cuban Americans to provide support for their Cuban national family members should produce customers loyal to the U.S. bank. That loyalty will be reinforced by the need to ensure that they have continued access to the system and method, giving them the additional incentive to maintain a good credit rating with the U.S. bank by making timely payments.

Third, the system and method of the present invention builds confidence and support within the affiliated Cuban bank(s), as well as the Cuban government. This confidence should give the U.S. bank an advantage over its competition in the finance industry. This advantage will be magnified when the current U.S. government embargo of Cuba is reduced or eliminated, and other credit cards from other U.S. banks or credit card companies are permitted to enter Cuba without the current OFAC restrictions.

D. Program Implementation and Use

Promoting and operating the system and method of the present invention will typically be the responsibility of the U.S. bank, with the support of the appropriate Cuban officials and agencies. Once introduced to the affiliated Cuban bank, the U.S. bank will then coordinate through its political relationships the necessary actions and approvals within the United States. This will permit the U.S. bank to take the lead in setting up and operating the system and method of the present invention. Through these contacts, the U.S. bank will need to be licensed with the OFAC in order to serve as an FRF. The U.S. bank will then need to establish, seek approval of, and then include with each credit application for the program a Cuban Remittance Affidavit, as dictated by the Cuban Assets Control Regulations. This approval will be a blanket affidavit for all withdrawals/transactions that a specific secondary cardholder (Cuban national) may execute.

The U.S. bank will then review, establish, or modify the processes needed to allow the bank's current systems to successfully interface with a secondary card (e.g., debit card) system set up at the affiliated Cuban bank. The Cuban debit card system is similar to the debit card system utilized in the United States. The Cuban debit card system was provided by the Canadian government and is used in place of currency by Cuban nationals. The Cuban debit card system would allow the secondary cardholder's card to work alongside the current debit cards should the expanded utilization of the present invention be implemented (as set forth above). However, in the first stage of implementation, the affiliated Cuban bank would need to recognize and interface with the U.S. bank's systems.

Cuba will assist executives and technical personnel from the U.S. bank and provide them with access to the Cuban debit card system, allowing the U.S. bank to create links for purchases and billing while controlling the spending limits set forth by the OFAC regulations.

The U.S. bank will market the system and method of the present invention to Cuban Americans who have relatives living in Cuba. Cuba will assist the marketing effort by providing the U.S. bank with contact information of Cuban Americans the Cuban government believes are related to Cuban nationals. The Cuban government and its organizations, such as the affiliated Cuban bank, will assist the U.S. bank by providing promotional letters from the U.S. bank to Cuban nationals. These letters will provide instructions for the Cuban nationals on how to approach their relatives in the United States and on how to direct them to securing a card from the U.S. bank. This personal appeal should increase participation from the Cuban Americans. The U.S. bank may also pursue the marketing of this program through its traditional marketing channels.

Once the system and method of the present invention have been promoted to the Cuban Americans and the Cuban nationals, and the U.S. bank is satisfied with the participation or enrollment, the U.S. bank may distribute a primary card (or cards) to a primary cardholder(s) (Cuban American(s) living in the United States). The affiliated Cuban bank would distribute the secondary card (or cards) to those secondary cardholder(s) approved by the OFAC. Card distribution would follow the signing and submission of the Cuban Remittance Affidavit by the Cuban American. The secondary card(s) would have preset spending limits imposed upon them that the U.S. bank would control through its in-house computer systems. The Affidavit would ensure that the secondary cards and the right to use such cards would only go to those eligible by U.S. regulations, i.e., 31 C.F.R. § 515 et seq. The U.S. bank would continue to be responsible for all regulatory reporting and documentation required under the U.S. laws and regulations.

The primary cardholders are responsible for the primary card account and should be citizens or residents of the United States. This ensures that the primary cardholder, the Cuban American, has the credit history needed to establish the account and provides a needed level of security for the U.S. bank. Therefore, all billings and payments from and to the U.S. bank will be in U.S. dollars. A withdrawal limit or spending limit for the secondary cardholder within the current limits dictated by the OFAC authorizes any individual subject to U.S. law to send up to $300 every three months ($1,200 annually) to any Cuban national who is a relative. Should the law in the future permit a different amount to be sent to a Cuban national or permit a different limit per a reporting period, the limits on the secondary card can be adjusted. The Cuban national secondary cardholder should also not be a senior-level official of the Communist Party of Cuba or a senior-level official of the government of Cuba. There is also a limit of one secondary cardholder per each Cuban national household. The primary cardholder may also request additional secondary cards for others living in the United States (in the same manner U.S. banks permit multiple names on a solely U.S.-based account). The U.S. bank may decide what limits to impose upon such additional secondary U.S. cards based upon the risk involved and/or what the U.S. banking regulations dictate. This would permit additional loans charged against the primary cardholder account.

The secondary cardholder may present the secondary card to the affiliated Cuban bank and physically make a withdrawal with presentation of adequate identification. If the system and method of the present invention are interfaced with the Cuban ATM system, then the secondary cardholder may use his/her secondary card at an accepting and approved Cuban merchant directly. The Cuban merchant would then have to go to an affiliated Cuban bank location (or access electronically, if available) and collect the cash for all transactions performed by the secondary cardholder within a set time frame. The secondary cardholder is effectively giving the merchant approval to claim the secondary cardholder's dollars. The Cuban merchants should also not be senior-level official(s) of the Communist Party of Cuba or senior-level official(s) of the government of Cuba.

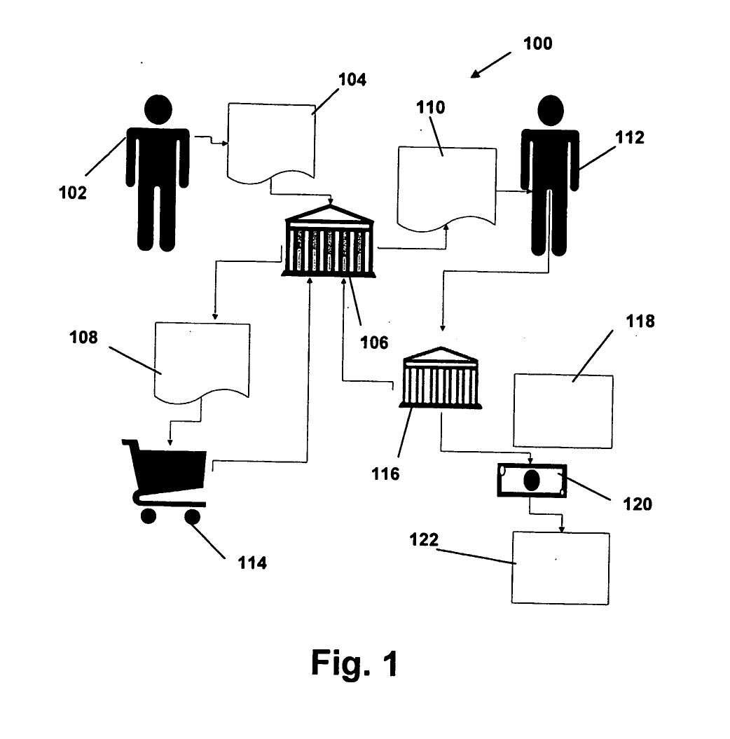

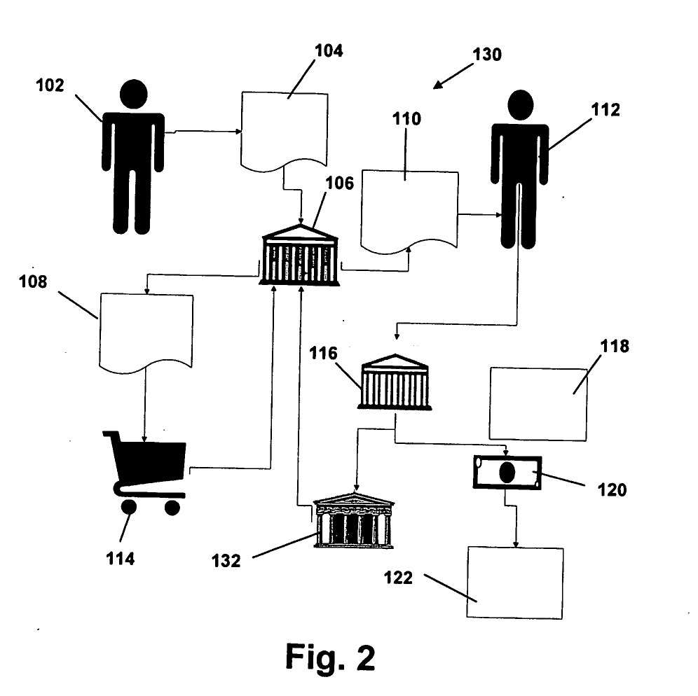

FIGS. 1 and 2 present schematic diagrams of the system and method of the present invention, generally designated as reference numeral 100 in FIG. 1 and reference numeral 130 in FIG. 2. As shown in FIG. 1, the Cuban American (or sponsor or primary cardholder) 102 will apply for a primary card at a U.S. bank (or sponsoring U.S. financial institution) 106. The Cuban American 102 will also submit to the U.S. bank 106 a Cuban Remittance Affidavit(s) 104 for each Cuban national 112 he/she intends to sponsor. The U.S. bank 106 will then issue a primary card (e.g., a credit card) 108 to the Cuban American 102, and a secondary card (e.g., a debit card) or cards 110 to the Cuban national(s) 112.

The Cuban American 102 may use the primary card 108, just like any other credit card, to make normal purchases 114, payment for which is received from the U.S. bank 106 and billed to the Cuban American 102. The Cuban national 112 may then present the secondary card 110 to an affiliated Cuban bank 116 and receive up to $300 per quarter (currently) 118 in the form of cash 120 (either in Pesos or in American dollars). The cash 120 received by the Cuban national 112 may then be used for personal needs 122. The affiliated Cuban bank 116 will receive payment for its cash disbursement from the U.S. bank 106, and the U.S. bank 106 will, in turn, bill the Cuban American 102.

The system and method 130 shown in FIG. 2 is almost identical to the system and method 100 shown in FIG. 1, with the exception that a hub bank 132 may be utilized to act as a clearinghouse bank between the affiliated Cuban bank 116 and the U.S. bank 106. In this case, the cash 120 issued by the Cuban bank 116 will be reimbursed by the hub bank 132, and the hub bank 132 will, in turn, be reimbursed by the U.S. bank 106. Once again, the U.S. bank 106 will bill the Cuban American 102 for the cash 120 disbursed to the Cuban national 112.

E. System Hardware

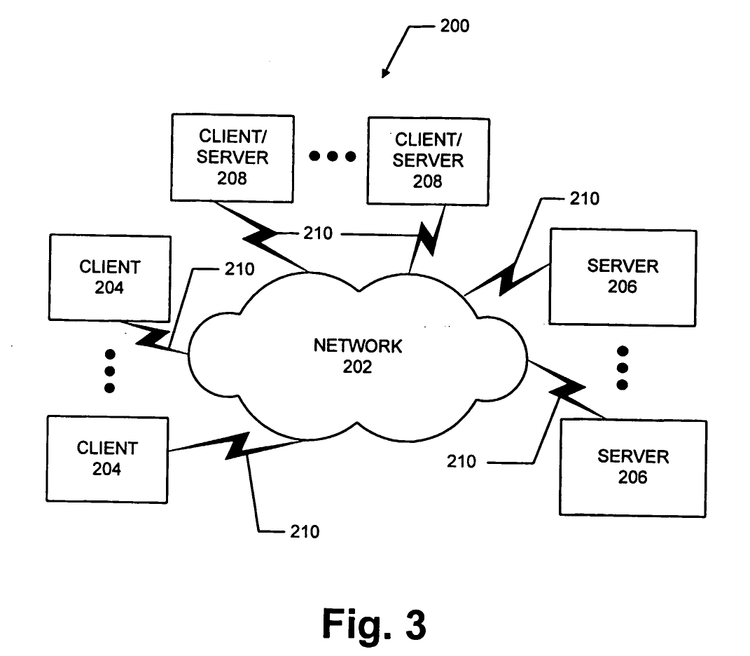

In accordance with the invention and as shown in FIG. 3, the system of the present invention includes a network 202 that interconnects client entities 204, server entities 206 and/or client/server entities 208, via communication links 210. Each bank (i.e., the U.S. bank 106, the Cuban bank 116, and possibly the hub bank 132) and possibly the merchants whom the Cuban Americans 102 and the Cuban nationals 112 make purchases from will connect into the network via client entities 204, server entities 206, client/server entities 208, or combinations thereof.

Network 202 may comprise an Internet, intranet, extranet, local area network (LAN), wide area network (WAN), metropolitan area network (MAN), telephone network such as the public switched telephone network (PSTN), or a similar network.

The Internet is a collection of interconnected (public and/or private) networks that are linked together by a set of standard protocols (such as TCP/IP and HTTP) to form a global, distributed network. While this term is intended to refer to what is now commonly known as the Internet, it is also intended to encompass variations which may be made in the future, including changes and additions to existing protocols.

An intranet is a private network that is contained within an enterprise. It may consist of many interlinked local area networks and also use leased lines in the wide area network. Typically, an intranet includes connections through one or more gateway computers to the outside Internet. The main purpose of an intranet is to share company information and computing resources among employees. An intranet can also be used to facilitate working in groups and for teleconferences. An intranet uses TCP/IP, HTTP, and other Internet protocols and in general looks like a private version of the Internet. With tunneling, companies can send private messages through the public network, using the public network with special encryption/decryption and other security safeguards to connect one part of their intranet to another. Typically, larger enterprises allow users within their intranet to access the public Internet through firewall servers that have the ability to screen messages in both directions so that company security is maintained. When part of an intranet is made accessible to customers, partners, suppliers, or others outside the company, that part becomes part of an extranet.

An extranet is a private network that uses the Internet protocols and the public telecommunication system to securely share part of a business's information or operations with suppliers, vendors, partners, customers, or other businesses. An extranet can be viewed as part of a company's intranet that is extended to users outside the company.

A LAN refers to a network where computing resources such as PCs, printers, minicomputers, and mainframes are linked by a common transmission medium such as coaxial cable. A LAN usually refers to a network in a single building or campus. A WAN is a public or private computer network serving a wide geographic area. A MAN is a data communication network covering the geographic area of a city, a MAN is generally larger than a LAN but smaller than a WAN.

PSTN refers to the world's collection of interconnected voice-oriented public telephone networks, both commercial and government-owned. It is the aggregation of circuit-switching telephone networks that has evolved from the days of Alexander Graham Bell. Today, PSTN is almost entirely digital in technology except for the final link from the central (local) telephone office to the user. In relation to the Internet, the PSTN actually furnishes much of the Internet's long-distance infrastructure.

An entity may include software, such as programs, threads, processes, information, databases, or objects; hardware, such as a computer, a laptop, a personal digital assistant (PDA), a wired or wireless telephone, or a similar wireless device; or a combination of both software and hardware. A client entity 204 is an entity that sends a request to a server entity and waits for a response. A server entity 206 is an entity that responds to the request from the client entity. A client/server entity 208 is an entity where the client and server entities reside in the same piece of hardware or software.

Communication links 210 may be wired, wireless, optical or a similar connection mechanism. “Wireless” refers to a communications, monitoring, or control system in which electromagnetic or acoustic waves carry a signal through atmospheric space rather than along a wire. In most wireless systems, radio-frequency (RF) or infrared (IR) waves are used. Some monitoring devices, such as intrusion alarms, employ acoustic waves at frequencies above the range of human hearing.

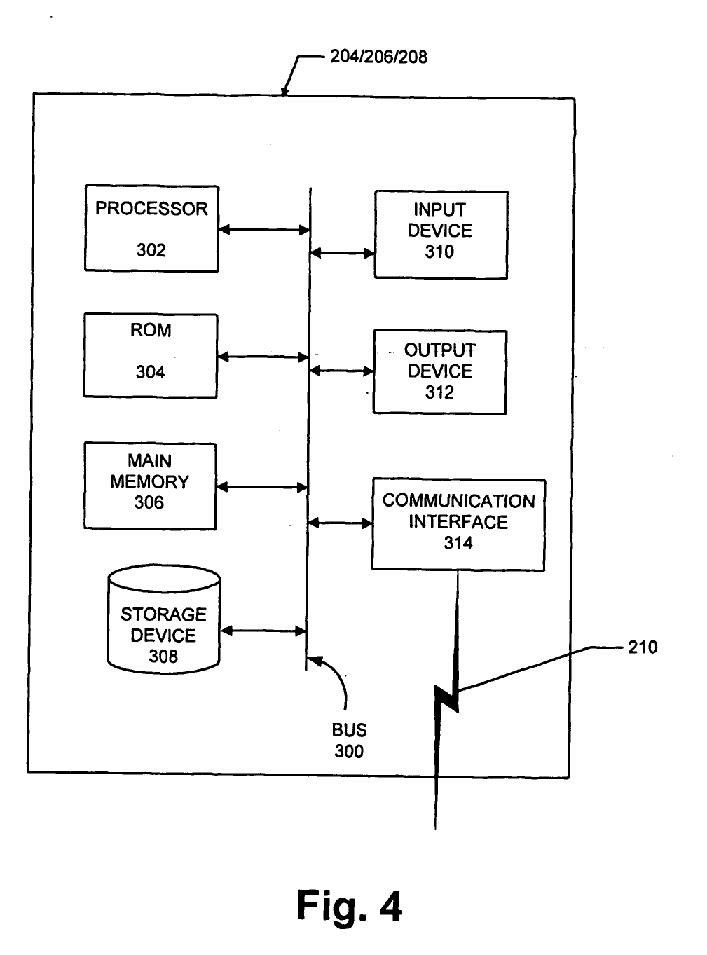

An entity, whether it be a client entity 204, a server entity 206, or a client/server entity 208, may include, as shown in FIG. 4, a bus 300 interconnecting a processor 302, a read-only memory (ROM) 304, a main memory 306, a storage device 308, an input device 310, an output device 312, and a communication interface 314. Bus 300 is a network topology or circuit arrangement in which all devices are attached to a line directly and all signals pass through each of the devices. Each device has a unique identity and can recognize those signals intended for it. Processor 302 includes the logic circuitry that responds to and processes the basic instructions that drive entity 204, 206, 208. ROM 304 includes a static memory that stores instructions and data used by processor 302.

Computer storage is the holding of data in an electromagnetic form for access by a computer processor. Main memory 306, which may be a RAM or another type of dynamic memory, makes up the primary storage of entity 204, 206, 208. Secondary storage of entity 204, 206, 208 may comprise a storage device 308, such as hard disks, tapes, diskettes, Zip drives, RAID systems, holographic storage, optical storage, CD-ROMs, magnetic tapes, and other external devices and their corresponding drives.

Input device 310 may include a keyboard, mouse, pointing device, sound device (e.g. a microphone, etc.), biometric device, or any other device providing input to entity 204, 206, 208. Output device 312 may comprise a display, a printer, a sound device (e.g. a speaker, etc.), or other device providing output to entity 204, 206, 208. Communication interface 314 may include network connections, modems, or other devices used for communications with other computer systems or devices.

An entity 204, 206, 208 consistent with the present invention may perform the method or portions of the method for transferring funds to Cuban nationals from the United States using a credit/debit card, as described previously. Entity 204, 206, 208 performs this task or tasks in response to processor 302 executing sequences of instructions contained in a computer-readable medium, such as main memory 306. A computer-readable medium may include one or more memory devices and/or carrier waves.

Execution of the sequences of instructions contained in main memory 306 causes processor 302 to perform the processes described above. Alternatively, hardwired circuitry may be used in place of or in combination with software instructions to implement processes consistent with the present invention. Thus, the present invention is not limited to any specific combination of hardware circuitry and software.

F. Potential Financial Returns

The system and method of the present invention would permit the U.S. bank to realize an additional $300 of loans per quarter for each household in Cuba who has a credit-worthy relative living in the United States. That $300 would equal $142,277,400 per quarter or $569,109,600 annually based on approximately 474,258 Cuban American households. If the U.S. bank obtains a thirty percent market share for only the loans to Cuban households, then $170,732,880 worth of loans for only withdrawals/transfers would be available. This assumes that only one primary cardholder is possible, that is, the number of transfers is based solely on the number of Cuban American households. More primary cardholders may be established should a Cuban American household possess more than one credit-worthy Cuban American living there. This is likely because Cuban Americans living in the United States currently number approximately 1,240,000. Income data is unavailable for strictly Cuban Americans. However, the median household income for all Latino households in the United States is $33,676, which would include those who have been in the United States much less time than the typical Cuban American.

With the present invention, the U.S. bank may also receive a fee of, for example, eight percent (or a $24 fee) for each withdrawal/transaction. This equates to approximately $3,414,650 quarterly or $13,658,630 annually prior to payment of a cash distribution fee to the affiliated Cuban bank and any miscellaneous U.S. bank facilitation fees. The eight percent is much less than what is currently being charged by, for example, the Western Union wire transfer system. Such lower fees should win over clients using such wire transfer systems.

Additionally, valuable benefits would accrue to the U.S. bank from the additional loans the U.S. bank could realize from the primary cardholder in the United States. The U.S. bank will also profit from all the benefits that another $170 million in annual loans will provide it.

Furthermore, the market potential for the system and method of the present invention appears to be growing for Cuba and other OFAC-regulated countries. For example, remittance services or FRF services have increased dramatically since the reinstatement of Remittance in 1997. As of August 1999, the OFAC had issued 214 travel-related and service-related licenses to 115 U.S.-based companies. As of August 1998, the OFAC had issued 144 travel-related and service-related licenses to 75 U.S.-based companies.

It will be apparent to those skilled in the art that various modifications and variations can be made in the system and method for transferring funds from the United States to nationals located in OFAC-regulated countries of the present invention and in construction of this system and method without departing from the scope or spirit of the invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for transferring funds from the United States to one or more nationals located in a country regulated by the Office of Foreign Assets Control (OFAC) of the U.S. Department of the Treasury using a primary/secondary card, comprising:
receiving an application for a primary card by a primary cardholder at a U.S. financial institution, the primary cardholder being an American resident from the country regulated by OFAC or a U.S. citizen having at least one relative who is a national located in the country regulated by OFAC;
issuing a secondary card from the U.S. financial institution to each national sponsored by the primary cardholder;
providing a monetary limit on each secondary card in accordance with the regulations set by OFAC; and
billing the primary cardholder for any cash distributed to or goods purchased with any of the secondary cards.

2. A method for transferring funds as recited in claim 1, wherein the step of providing a monetary limit comprises providing two or more monetary limits on each secondary card, wherein a first monetary limit is set for one OFAC-regulated country and a second monetary limit is set for another OFAC-regulated country.

3. A method for transferring funds as recited in claim 1, further comprising receiving a remittance affidavit at the U.S. financial institution for each national that the primary cardholder intends to sponsor.

4. A method for transferring funds as recited in claim 1, further comprising issuing a primary card from the U.S. financial institution to the primary cardholder.

5. A method for transferring funds as recited in claim 4, further comprising providing a monetary limit on the primary card in accordance with a credit rating of the primary cardholder.

6. A method for transferring funds as recited in claim 4, further comprising billing the primary cardholder for any cash distributed to or goods purchased with the primary card.

7. A computer-implemented system for transferring funds from the United States to one or more nationals located in a country regulated by the Office of Foreign Assets Control (OFAC) of the U.S. Department of the Treasury using a primary/secondary card, the system comprising:
a memory configured to store instructions; and
a processor configured to execute instructions for:
receiving an application for a primary card by a primary cardholder at a U.S. financial institution, the primary cardholder being an American resident from the country regulated by OFAC or a U.S. citizen having at least one relative who is a national located in the country regulated by OFAC,
issuing a secondary card from the U.S. financial institution to each national sponsored by the primary cardholder,
providing a monetary limit on each secondary card in accordance with the regulations set by OFAC, and
billing the primary cardholder for any cash distributed to or goods purchased with any of the secondary cards.

8. A computer-implemented system for transferring funds as recited in claim 7, wherein the instructions for providing a monetary limit comprises providing two or more monetary limits on each secondary card, wherein a first monetary limit is set for one OFAC-regulated country and a second monetary limit is set for another OFAC-regulated country.

9. A computer-implemented system for transferring funds as recited in claim 7, wherein the processor is further configured to execute instructions for receiving a remittance affidavit at the U.S. financial institution for each national that the primary cardholder intends to sponsor.

10. A computer-implemented system for transferring funds as recited in claim 7, wherein the processor is further configured to execute instructions for issuing a primary card from the U.S. financial institution to the primary cardholder.

11. A computer-implemented system for transferring funds as recited in claim 10, wherein the processor is further configured to execute instructions for providing a monetary limit on the primary card in accordance with a credit rating of the primary cardholder.

12. A computer-implemented system for transferring funds as recited in claim 10, wherein the processor is further configured to execute instructions for billing the primary cardholder for any cash distributed to or goods purchased with the primary card.

13. A computer-implemented method for transferring funds from the United States to one or more nationals located in a country regulated by the Office of Foreign Assets Control (OFAC) of the U.S. Department of the Treasury using a primary/secondary card, comprising:
receiving an application for a primary card by a primary cardholder at a U.S. financial institution, the primary cardholder being an American resident from the country regulated by OFAC or a U.S. citizen having at least one relative who is a national located in the country regulated by OFAC;
issuing a secondary card from the U.S. financial institution to each national sponsored by the primary cardholder;
providing a monetary limit on each secondary card in accordance with the regulations set by OFAC; and
billing the primary cardholder for any cash distributed to or goods purchased with any of the secondary cards.

14. A computer-implemented method for transferring funds as recited in claim 13, wherein the step of providing a monetary limit comprises providing two or more monetary limits on each secondary card, wherein a first monetary limit is set for one OFAC-regulated country and a second monetary limit is set for another OFAC-regulated country.

15. A computer-implemented method for transferring finds as recited in claim 13, further comprising receiving a remittance affidavit at the U.S. financial institution for each national that the primary cardholder intends to sponsor.

16. A computer-implemented method for transferring funds as recited in claim 13, further comprising issuing a primary card from the U.S. financial institution to the primary cardholder.

17. A computer-implemented method for transferring funds as recited in claim 16, further comprising providing a monetary limit on the primary card in accordance with a credit rating of the primary cardholder.

18. A computer-implemented method for transferring funds as recited in claim 16, further comprising billing the primary cardholder for any cash distributed to or goods purchased with the primary card.

19. A computer readable medium that stores instructions executable by at least one processor to perform a method for transferring funds from the United States to one or more nationals located in a country regulated by the Office of Foreign Assets Control (OFAC) of the U.S. Department of the Treasury using a primary/secondary card, comprising instructions for:
receiving an application for a primary card by a primary cardholder at a U.S. financial institution, the primary cardholder being an American resident from the country regulated by OFAC or a U.S. citizen having at least one relative who is a national located in the country regulated by OFAC;
issuing a secondary card from the U.S. financial institution to each national sponsored by the primary cardholder;
providing a monetary limit on each secondary card in accordance with the regulations set by OFAC; and
billing the primary cardholder for any cash distributed to or goods purchased with any of the secondary cards.

20. A computer readable medium as recited in claim 19, wherein the instructions for providing a monetary limit comprises providing two or more monetary limits on each secondary card, wherein a first monetary limit is set for one OFAC-regulated country and a second monetary limit is set for another OFAC-regulated country.

21. A computer readable medium as recited in claim 19, further comprising instructions for receiving a remittance affidavit at the U.S. financial institution for each national that the primary cardholder intends to sponsor.

22. A computer readable medium as recited in claim 19, further comprising instructions for issuing a primary card from the U.S. financial institution to the primary cardholder.

23. A computer readable medium as recited in claim 22, further comprising instructions for providing a monetary limit on the primary card in accordance with a credit rating of the primary cardholder.

24. A computer readable medium as recited in claim 22, further comprising instructions for billing the primary cardholder for any cash distributed to or goods purchased with the primary card.
